(19) United States
(12) Patent Application Publication
(10) Pub. No.: US 2018/0139092 A1
(43) Pub. Date: May 17, 2018

(54) INFORMATION PROCESSING APPARATUS AND METHOD FOR CREATING CONFIGURATION INFORMATION LIST

(71) Applicant: FUJITSU LIMITED, Kawasaki-shi (JP)

(72) Inventors: Tomoya KONISHI, Kawasaki (JP); Takahiro KIDA, Oota (JP); Masashi SUMI, Hadano (JP)

(73) Assignee: FUJITSU LIMITED, Kawasaki-shi (JP)

(21) Appl. No.: 15/788,858

(22) Filed: Oct. 20, 2017

(30) Foreign Application Priority Data
Nov. 11, 2016 (JP) 2016-220734

(51) Int. Cl. H04L 12/24

(52) U.S. Cl. CPC H04L 41/0806; H04L 41/0853

(57) ABSTRACT

An information processing apparatus includes a storage unit and a processing unit. The storage unit stores a command for acquiring configuration information from a target apparatus, in association with the name of the apparatus. The processing unit acquires the name of the target apparatus that is subjected to acquisition of configuration information, by accessing the target apparatus present on a network, based on access information for accessing the target apparatus. The processing unit acquires the configuration information from the target apparatus, by causing the target apparatus to execute the command associated with the name of the target apparatus. Further, the processing unit creates a configuration information list listing the configuration information.

### CROSS-REFERENCE TO RELATED APPLICATION

This application is based upon and claims the benefit of priority of the prior Japanese Patent Application No. 2016-220734, filed on Nov. 11, 2016, the entire contents of which are incorporated herein by reference.

### FIELD

The embodiments discussed herein are related to an information processing apparatus and a method for creating a configuration information list.

### BACKGROUND

In recent years, the process of constructing a business system including apparatuses such as a network switch, a server, a storage, and the like in combination has been increasingly automated. For example, in the case of application-specific systems such as virtualization platforms, it has become more common to construct a system using a software tool that automates the construction process.

Among techniques for business system construction, there is, for example, a technique that extracts the difference between a system model and a real system, and manages the system model based on the extracted difference. There is, for example, also a technique that holds a connection relationship between components of a system and their configuration information, and constructs a virtual network system based on the configuration information.

See, for example, International Publication Pamphlet No. WO2011/052148 and Japanese Laid-open Patent Publication No. 2014-154925.

A configuration information list is created that lists various parameters (configuration information) specified for each apparatus included in a business system. The configuration information list is provided as a part of the product delivered to the customer after the business system is constructed, for example. However, the process of obtaining configuration information from each apparatus and creating a configuration information list is performed manually, which reduces the work efficiency.

### SUMMARY

According to one aspect of the embodiments, there is provided an information processing apparatus that includes: a memory configured to store a command for acquiring configuration information from an apparatus, in association with a name of the apparatus; and a processor configured to perform a procedure including: acquiring a name of a target apparatus that is subjected to acquisition of configuration information, by accessing the target apparatus present on a network, based on access information for accessing the target apparatus, acquiring the configuration information from the target apparatus, by causing the target apparatus to execute the command associated with the name of the target apparatus, and creating a configuration information list listing the configuration information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of functions of an information processing apparatus according to a first embodiment;

FIG. 2 illustrates the flow of manually creating a design sheet after construction of a business system, and delivering the design sheet;

FIG. 3 illustrates an exemplary configuration of a design sheet creation apparatus used in a second embodiment;

FIG. 4 illustrates an exemplary configuration of a database;

FIG. 5 illustrates an exemplary configuration of an IP system and community name table;

FIG. 6 illustrates an exemplary configuration of a user information table;

FIG. 7 illustrates an exemplary configuration of an apparatus information table;

FIG. 8 illustrates an exemplary configuration of a configuration information acquisition command table;

FIG. 9 illustrates an example of a manual design sheet file;

FIG. 10 illustrates an example of a machine-made design sheet file;

FIG. 11 illustrates an example of a difference information text file;

FIG. 12 illustrates an exemplary hardware configuration of a design sheet creation apparatus;

FIGS. 13 to 18 are operation sequence diagrams each related to creation of a machine-made design sheet;

FIG. 19 is a flowchart illustrating a procedure for writing the execution result of a configuration information acquisition command to a machine-made design sheet;

FIG. 20 illustrates an operational flow for creating a machine-made design sheet;

FIG. 21 illustrates an operational flow in the case where there is an unregistered apparatus when creating a machine-made design sheet;

FIG. 22 illustrates an operational flow for outputting difference information when creating a machine-made design sheet; and

FIG. 23 illustrates the flow of creating a machine-made design sheet using a design sheet creation apparatus after construction of a business system, and delivering the design sheet.

### DESCRIPTION OF EMBODIMENTS

Several embodiments will be described below with reference to the accompanying drawings, wherein like reference numerals refer to like elements throughout. Features of certain embodiments may be combined with features of other embodiments as long as no inconsistency arises.

### (a) First Embodiment

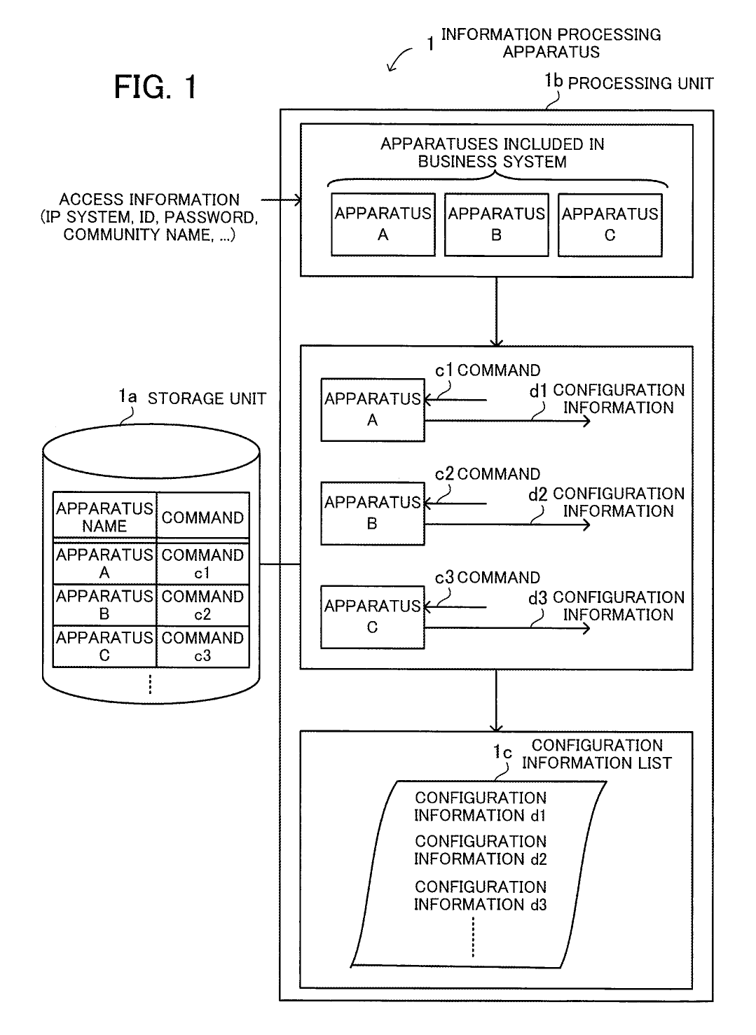

FIG. 1 illustrates an example of functions of an information processing apparatus 1 according to a first embodiment. The information processing apparatus 1 includes a storage unit 1a and a processing unit 1b. The storage unit 1a is, for example, a memory of the information processing apparatus 1. The processing unit 1b is, for example, a processor of the information processing apparatus 1.

The storage unit 1a stores a command for acquiring configuration information specified for an apparatus, in association with the name of the apparatus. In the example of FIG. 1, a command c1 corresponding to an apparatus A, a command c2 corresponding to an apparatus B, and a command c3 corresponding to an apparatus C are stored in the storage unit 1a.

The processing unit 1b receives an input of access information for accessing an apparatus, and determines an apparatus included in a system, based on the access information.

The access information includes, for example, Internet Protocol system (IP address system) as information for identifying an apparatus; and ID, password, community name, and so on as information for authenticating the apparatus. In the example of FIG. 1, the processing unit 1b determines an apparatus included in a system, based on such access information.

The processing unit 1b executes a command for acquiring configuration information specified for the determined apparatus, and acquires the configuration information from the apparatus. In the example of FIG. 1, the processing unit 1b executes the command c1 on the apparatus A, and acquires configuration information d1 returned from the apparatus A.

Similarly, the processing unit 1b executes the command c2 on the apparatus B, and acquires configuration information d2 returned from the apparatus B. The processing unit 1b also executes the command c3 on the apparatus C, and acquires configuration information d3 returned from the apparatus C.

Further, the processing unit 1b creates a configuration information list listing the configuration information. In the example of FIG. 1, the processing unit 1b creates a configuration information list 1c listing the configuration information d1, the configuration information d2, and the configuration information d3.

As described above, the information processing apparatus 1 registers in advance a command for acquiring configuration information from an apparatus included in a system, executes the command to acquire the configuration information, and creates a configuration information list listing the configuration information. Thus, the process for creating a configuration information list is automated, which improves the work efficiency.

Further, if a command corresponding to the name of a managed apparatus is not stored in the storage unit 1a, the processing unit 1b may output an input request for a command for acquiring configuration information from the managed apparatus. For example, the processing unit 1b displays an input request on the monitor. Then, the processing unit 1b stores a command that is input in response to the input request, in the storage unit 1a, in association with the name of the managed apparatus. Thus, even if there is an apparatus for which a command is not registered in advance among managed apparatuses, it is possible to create the configuration information list 1c including the configuration information of that apparatus. That is, it is possible to easily create the configuration information list 1c with no missing information.

Further, if another configuration information list that is input from the outside is stored in the storage unit 1a, the processing unit 1b may extract difference information between the created configuration information list 1c and the other configuration information list. The other configuration information list is, for example, one that is manually created when a system to be constructed is designed. By comparing the configuration information list 1c created by the processing unit 1b with the configuration information list created manually, it is possible to detect a configuration error in the real system as the difference, for example. Accordingly, a configuration error is easily detected, so that it is possible to correct the correction error before starting operations, and improve the reliability of the system.

The access information described above indicates, for example, a range of addresses used by a managed apparatus. In this case, the processing unit 1b transmits a first command for checking whether a managed apparatus is present to each of the addresses within the range, for example. If a response to the first command transmitted to a specific address is received, the processing unit 1b transmits a second command for querying the name of a managed apparatus to the specific address. Then, the processing unit 1b acquires the name of the managed apparatus from the information returned in response to the second command. In this manner, it is possible to detect all the managed apparatuses connected to the network without missing any, and acquire configuration information of each of the managed apparatuses. This makes it possible to create the reliable configuration information list 1c without any missing information.

### (b) Second Embodiment

Next, a second embodiment will be described. In the second embodiment, the flow of determining each hardware apparatus included in a business system such as a network system or the like; acquiring configuration information as various parameters from the apparatus; and creating a configuration information list is automated. Note that the configuration information list will be hereinafter referred to as a “design sheet”.

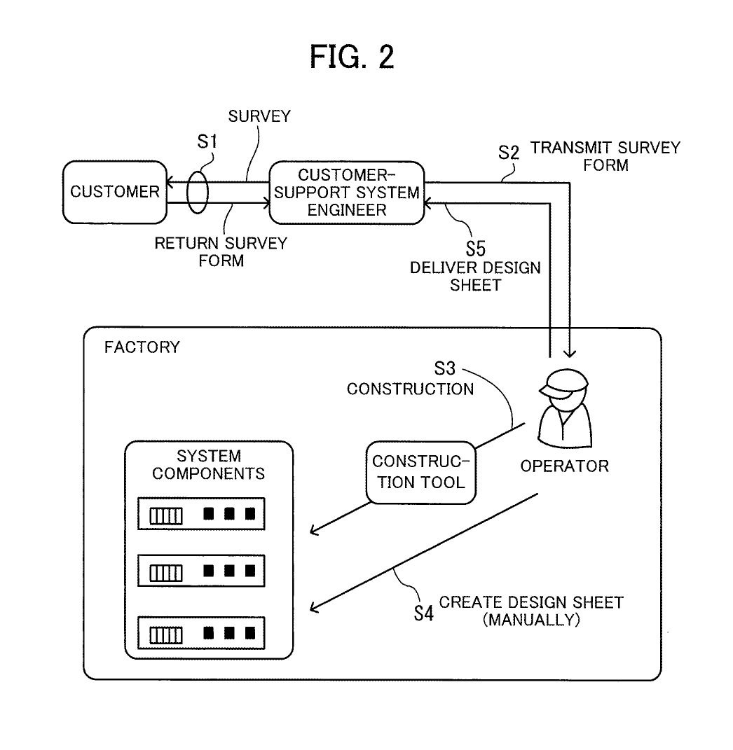

FIG. 2 illustrates the flow of manually creating a design sheet after construction of a business system, and delivering the design sheet.

(Step S1) In a business meeting with a customer, a customer-support system engineer (SE) asks the customer about the hardware configuration (for example, the number of servers, the model of apparatuses, and so on) of a business system that the customer wishes to install.

Further, the system engineer asks the customer for information on the IP addresses assigned to the individual apparatuses to be included in the business system. The result of such survey is recorded on a survey form as access information.

(Step S2) The system engineer transmits the survey form to an operator who constructs a system in the factory.

(Step S3) The operator having received the survey form imports the access information included in the survey form into a construction tool serving as a software tool that automates the construction process. Then, the operator uses the construction tool having the access information imported therein to automatically construct the business system.

(Step S4) The operator accesses each apparatus of the constructed business system to check the configuration information of the accessed apparatus, and manually creates a design sheet including the configuration information.

(Step S5) The operator provides the created design sheet as a deliverable. In the example of FIG. 2, the business system constructed in the factory is disassembled into individual apparatuses and delivered to the customer, and is constructed again at the customer site.

As illustrated in FIG. 2, even when the business system is automatically constructed by the construction tool, the design sheet is created manually.

In this case, the operator checks commands for acquiring configuration information from the respective target apparatuses included in the business system, and manually executes the commands on the respective apparatuses one by one. Then, the operator collects and checks the configuration information, and records the configuration information on the design sheet. Since such work is performed to create the design sheet, the work efficiency is reduced. Further, the greater the scale of the business system, the greater the number of target apparatuses from which configuration information is collected. This results in more man-hours to create the design sheet.

In view of these circumstances, the second embodiment aims to improve the work efficiency by automating the process for determining an apparatus included in a business system, acquiring configuration information specified for the apparatus, and creating a design sheet listing the configuration information.

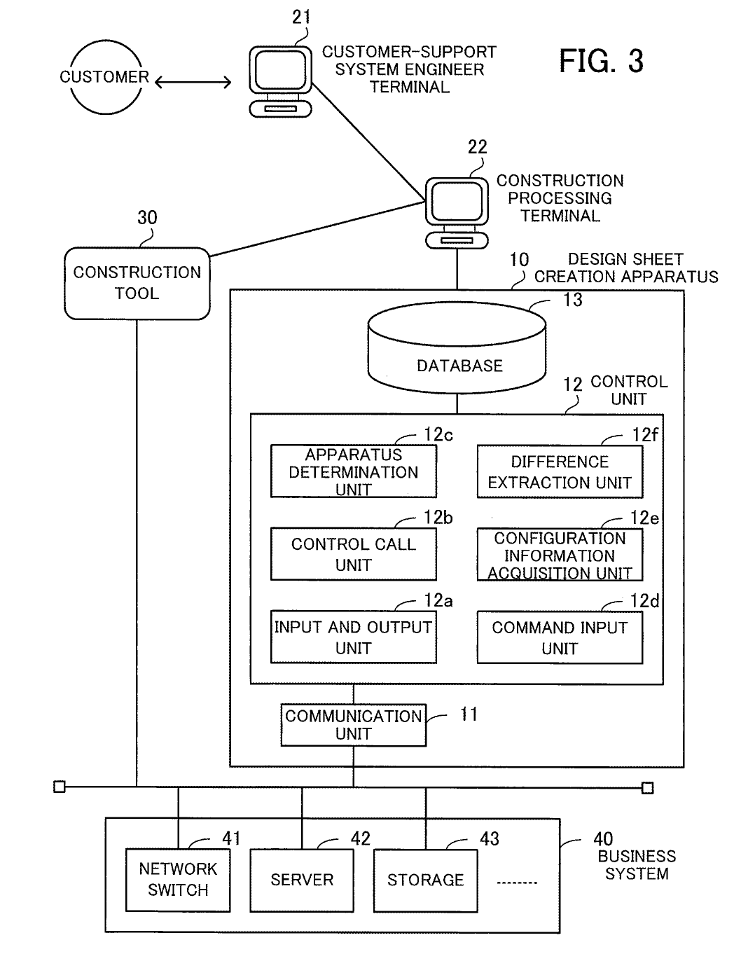

FIG. 3 illustrates an exemplary configuration of a design sheet creation apparatus 10 used in the second embodiment. The design sheet creation apparatus 10 connects to a construction processing terminal 22, a construction tool 30, and a business system 40. The construction processing terminal 22 connects to a customer-support system engineer terminal 21 and the construction tool 30.

The business system 40 is, for example, a network system. In the example of FIG. 3, a network switch 41, a server 42, and a storage 43 are illustrated as target apparatuses included in the business system 40.

The design sheet creation apparatus 10 includes a communication unit 11, a control unit 12, and a database 13. The control unit 12 includes an input and output unit 12a, a control call unit 12b, an apparatus determination unit 12c, a command input unit 12d, a configuration information acquisition unit 12e, and a difference extraction unit 12f.

The communication unit 11 includes a network port (for example, local area network (LAN) port) for communicating with the target apparatuses of the business system 40. Thus, the communication unit 11 communicates with the target apparatuses via the network port.

The input and output unit 12a receives inputs such as access information (IP system, ID, and password of a target apparatus, and so on), a manually created design sheet, and so on, from the construction processing terminal 22, and stores the input information in the database 13.

Note that a design sheet created automatically by the design sheet creation apparatus 10 will be hereinafter referred to as a “machine-made design sheet”, and a design sheet created manually will be hereinafter referred to as a “manual design sheet”.

Further, the input and output unit 12a outputs to the construction processing terminal 22 the machine-made design sheet, and the difference information between the machine-made design sheet and the manual design sheet.

The control call unit 12b determines which of the components of the control unit 12 is to perform the next operation, based on the information obtained via the components, and outputs a specific operation instruction to the determined component.

The apparatus determination unit 12c determines a target apparatus, based on the access information that is input by the input and output unit 12a. For example, the apparatus determination unit 12c pings each IP address on the network of the business system 40, and determines whether a target apparatus is present, based on the response.

Then, the apparatus determination unit 12c determines, for the IP address on the network where an apparatus is present, whether the apparatus is a target apparatus included in the business system 40, using a network management protocol such as Simple Network Management Protocol (SNMP) or the like.

For example, when an SNMP-GET command is transmitted to an apparatus whose presence is determined by ping, inventory information is returned from the apparatus. The inventory information includes the apparatus name, the serial number, and so on. Accordingly, based on the returned inventory information, the apparatus determination unit 12c is able to determine whether the apparatus is a target apparatus included in the business system 40. Thus, it is possible to accurately automatically determine an apparatus included in a business system.

In the case where a command for acquiring configuration information (hereinafter referred to as a configuration information acquisition command) from the target apparatus determined by the apparatus determination unit 12c is not stored in the database 13, the command input unit 12d newly registers a configuration information acquisition command for the target apparatus in the database 13.

More specifically, in the case where a configuration information acquisition command for the apparatus determined by the apparatus determination unit 12c is not stored in the database 13, the command input unit 12d displays, for example, a console to newly register the corresponding relationship between the target apparatus and a configuration information acquisition command in the database 13.

Then, the command input unit 12d requests the construction processing terminal 22 to input a configuration information acquisition command corresponding to the target apparatus, and stores the input configuration information acquisition command in the database 13.

The configuration information acquisition unit 12e executes the configuration information acquisition command on the target apparatus determined by the apparatus determination unit 12c to acquire configuration information, creates a machine-made design sheet based on the acquired configuration information, and stores the machine-made design sheet in the database 13.

For example, the configuration information acquisition unit 12e acquires a configuration information acquisition command corresponding to the target apparatus determined by the apparatus determination unit 12c from the database 13. Then, the configuration information acquisition unit 12e executes the configuration information acquisition command on the target apparatus, writes the configuration information returned from the target apparatus to a machine-made design sheet, and stores the machine-made design sheet in the database 13.

In the case where a manual design sheet is stored in the database 13, the difference extraction unit 12f finds the difference between the machine-made design sheet and the manual design sheet, and stores the difference information in the database 13.

For example, in the case where a manual design sheet created in advance is stored in the database 13, the difference extraction unit 12f obtains difference information between the machine-made design sheet created by the configuration information acquisition unit 12e and the manual design sheet (for example, obtains the difference using a diff command). Then, the difference extraction unit 12f writes the difference information to a text file, and stores the text file in the database 13.

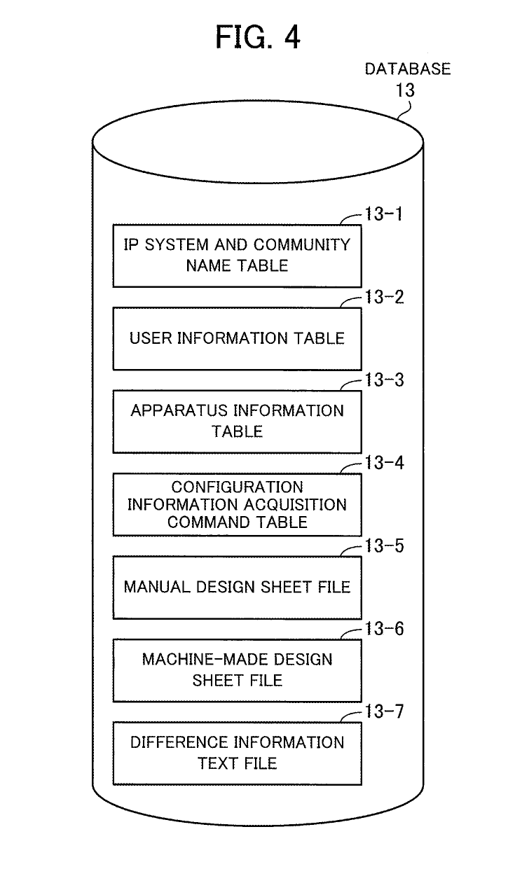

FIG. 4 illustrates an exemplary configuration of the database 13. The database 13 stores at least seven types of data. More specifically, the database 13 stores an IP system and community name table 13-1, a user information table 13-2, an apparatus information table 13-3, and a configuration information acquisition command table 13-4. The database 13 also stores a manual design sheet file 13-5, a machine-made design sheet file 13-6, and a difference information text file 13-7.

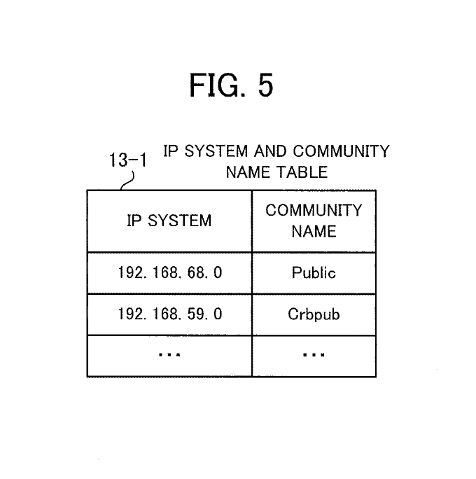

FIG. 5 illustrates an exemplary configuration of the IP system and community name table 13-1. The IP system and community name table 13-1 is a table that defines IP systems of the networks in the business system 40 and the community names. An IP system indicates the address of the network portion (network address) representing a range of IP addresses used by the corresponding community, for example. The IP addresses having the network address indicated by the IP system are used by apparatuses belonging to the corresponding community. The community name indicates the name for identifying the community representing the range to be managed. Apparatuses belonging to the same community are given the same community name.

The IP system and community name table 13-1 has the attributes “IP SYSTEM” and “COMMUNITY NAME”. The “COMMUNITY NAME” is used as authentication information to check the community that is set in advance in the design sheet creation apparatus 10 and the target apparatus, when exchanging information between the design sheet creation apparatus 10 and the target apparatus.

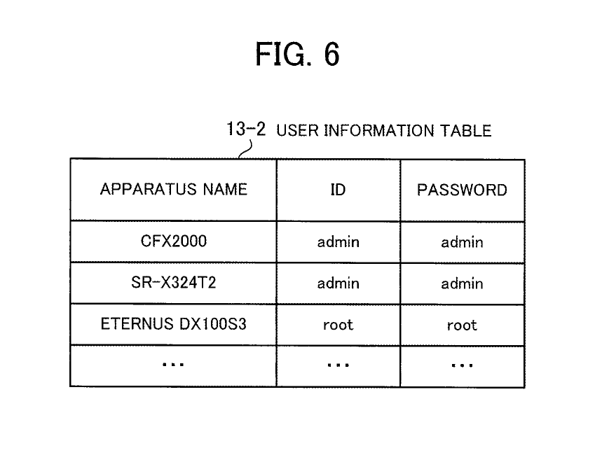

FIG. 6 illustrates an exemplary configuration of the user information table 13-2. The user information table 13-2 is a table that defines user information of the target apparatuses. The user information table 13-2 has the attributes “APPARATUS NAME”, “ID”, and “PASSWORD”.

The “IP system” and “COMMUNITY NAME” of the IP system and community name table 13-1 and the “APPARATUS NAME”, “ID”, and “PASSWORD” of the user information table 13-2 are information specified by the customer. That is, these attributes are access information that is input based on the survey form.

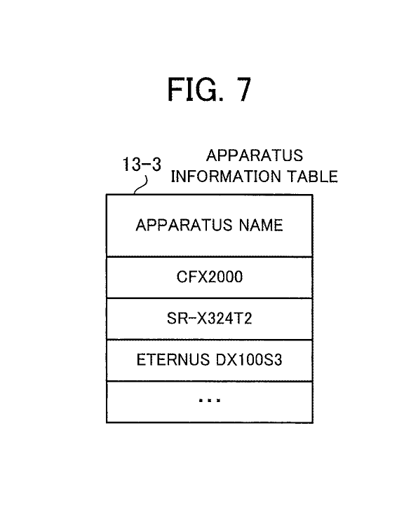

FIG. 7 illustrates an exemplary configuration of the apparatus information table 13-3. The apparatus information table 13-3 is a table that stores the apparatuses supported by the design sheet creation apparatus 10. The apparatus information table 13-3 has the attribute “APPARATUS NAME”.

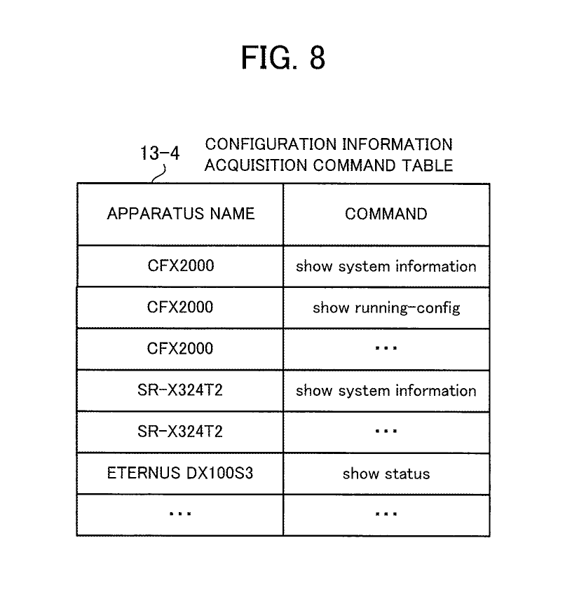

FIG. 8 illustrates an exemplary configuration of the configuration information acquisition command table 13-4. The configuration information acquisition command table 13-4 is a table that defines commands for acquiring configuration information from target apparatuses.

The configuration information acquisition command table 13-4 has the attributes “APPARATUS NAME” and “COMMAND”. Note that the elements of “APPARATUS NAME” stored in the apparatus information table 13-3 of FIG. 7 are also stored as the elements of “APPARATUS NAME” of the configuration information acquisition command table 13-4.

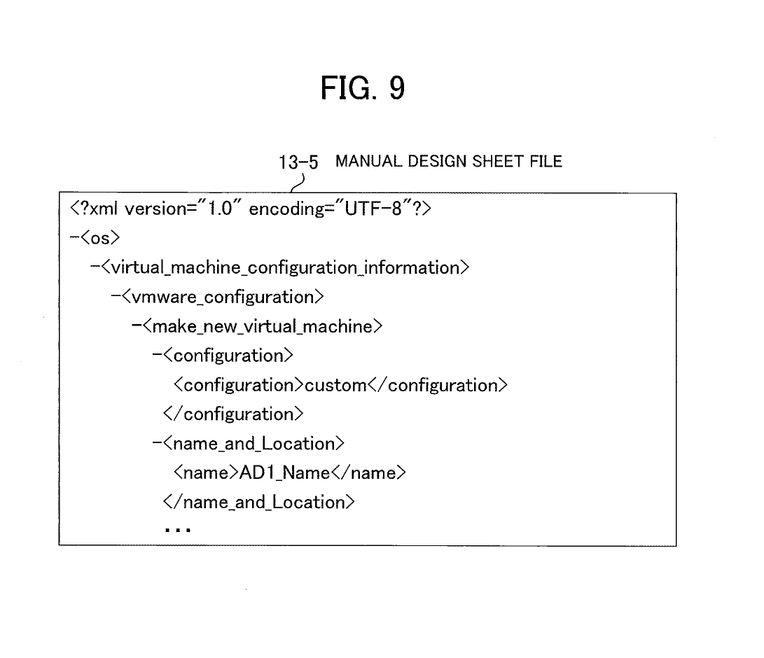

FIG. 9 illustrates an example of the manual design sheet file 13-5. The manual design sheet file 13-5 is a file of a manual design sheet that is created manually. The example of the manual design sheet file 13-5 illustrated in FIG. 9 is the one that is written in an Extensible Markup Language (XML) format, for example.

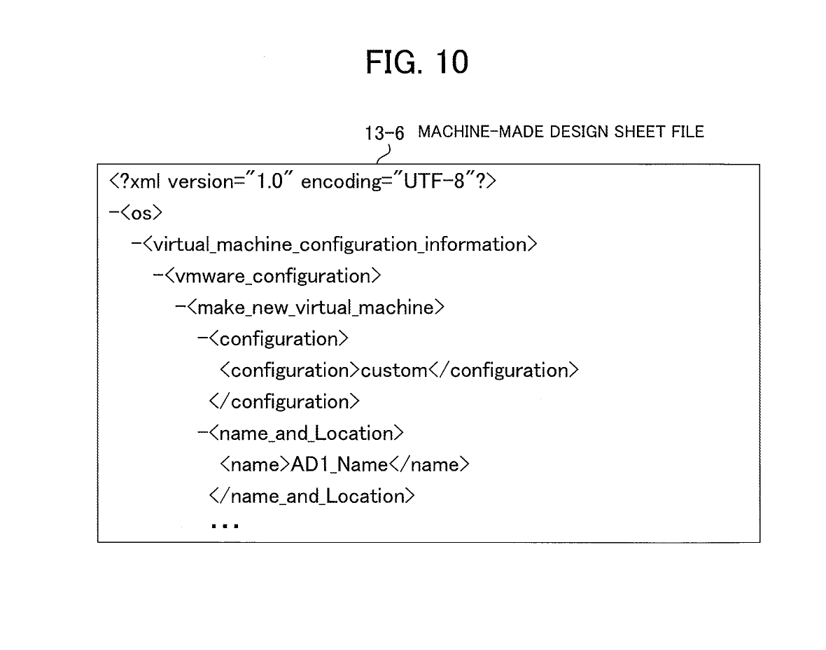

FIG. 10 illustrates an example of the machine-made design sheet file 13-6. The machine-made design sheet file 13-6 is a file of a machine-made design sheet that is created based on configuration information acquired from each target apparatus by executing a configuration information acquisition command on the target apparatus. The example of the machine-made design sheet file 13-6 illustrated in FIG. 10 is the one that is written in an XML format, for example.

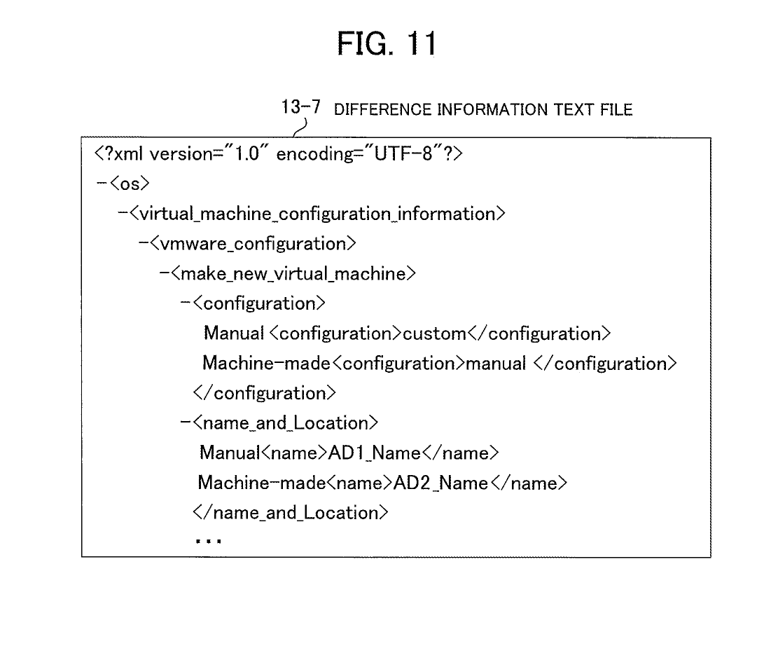

FIG. 11 illustrates an example of the difference information text file 13-7. The difference information text file 13-7 is a text file that indicates the difference information between a manual design sheet and a machine-made design sheet. The example of the difference information text file 13-7 illustrated in FIG. 11 is the one that is written in an XML format, for example.

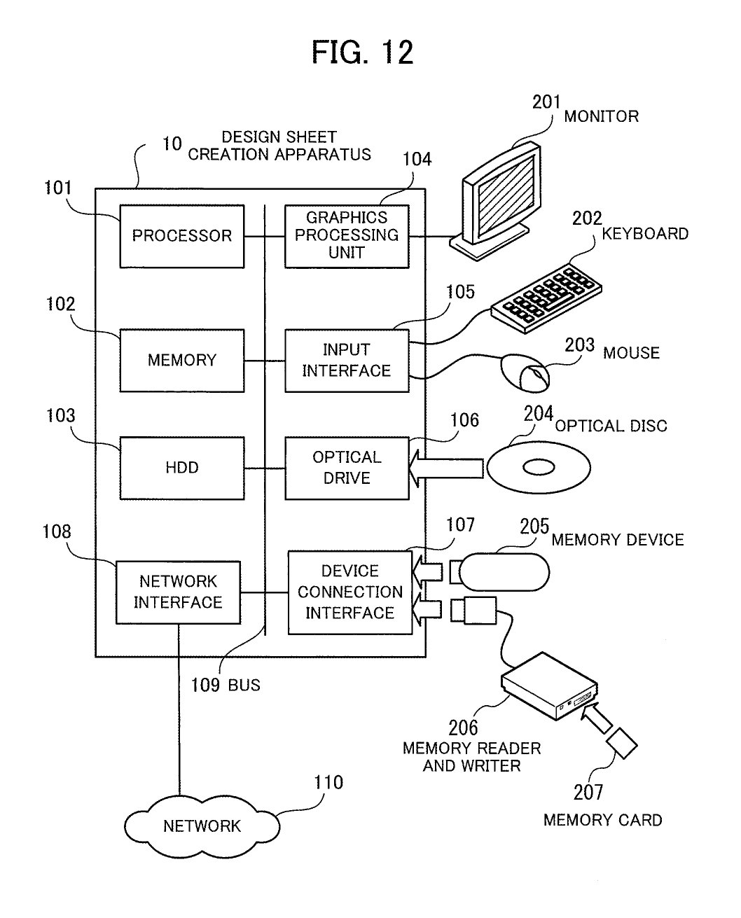

In the following, the configuration of the design sheet creation apparatus 10 will be described. FIG. 12 illustrates an exemplary hardware configuration of the design sheet creation apparatus 10. The overall operation of the design sheet creation apparatus 10 is controlled by a processor 101 (for example, the operation of the control unit 12 is performed by the processor 101).

A memory 102 and a plurality of peripheral devices are connected to the processor 101 via a bus 109. The processor 101 may be a multiprocessor. Examples of the processor 101 include central processing unit (CPU), micro processing unit (MPU), and digital signal processor (DSP). The functions of the processor 101 may be implemented wholly or partly by using electronic circuits such as application-specific integrated circuit (ASIC), programmable logic device (PLD), and the like.

The memory 102 is used as a primary storage device of the design sheet creation apparatus 10, and corresponds to, for example, the database 13. The memory 102 temporarily stores at least part of the operating system (OS) program and application programs that are executed by the processor 101.

The memory 102 also stores various types of data needed for the processing performed by the processor 101. Examples of the memory 102 include volatile semiconductor storage device such as random access memory (RAM) and the like.

The peripheral devices connected to the bus 109 include a hard disk drive (HDD) 103, a graphics processing unit 104, an input interface 105, an optical drive 106, a device connection interface 107, and a network interface 108.

The HDD 103 magnetically writes data to and reads data from its internal disk. The HDD 103 serves as a secondary storage device of the design sheet creation apparatus 10. The HDD 103 stores the OS program, application programs, and various types of data. Note that a non-volatile semiconductor storage device such as flash memory and the like may be used as a secondary storage device.

A monitor 201 is connected to the graphics processing unit 104. The graphics processing unit 104 displays an image (for example, displays difference information and so on) on the screen of the monitor 201, in accordance with a command from the processor 101. Examples of the monitor 201 include display device using a cathode ray tube (CRT), liquid crystal display device, and the like.

A keyboard 202 and a mouse 203 are connected to the input interface 105. The input interface 105 receives signals from the keyboard 202 and the mouse 203, and transmits the received signals to the processor 101.

The mouse 203 is an example of a pointing device, and other types of pointing devices may also be used. Examples of other types of pointing devices include touch panel, tablet, touch pad, track ball, and the like.

The optical drive 106 reads data from an optical disc 204 by using laser beams or the like. The optical disc 204 is a portable storage medium and stores data such that the data may be read through optical reflection.

Examples of the optical disc 204 include digital versatile disc (DVD), DVD-RAM, compact disc read only memory (CD-ROM), CD-Recordable (CD-R), CD-Rewritable (CD-RW), and the like.

The device connection interface 107 is a communication interface that connects peripheral devices to the design sheet creation apparatus 10. For example, the construction processing terminal 22, the business system 40, a memory device 205, and a memory reader and writer 206 may be connected to the device connection interface 107.

The memory device 205 is a storage medium having a function to communicate with the device connection interface 107. The memory reader and writer 206 is a device that writes data to a memory card 207 and reads data from the memory card 207. The memory card 207 is a card-type storage medium.

The network interface 108 is connected to a network 110. The network interface 108 corresponds to, for example, the communication unit 11, and exchanges data with other computers or communication apparatuses via the network 110.

With the hardware configuration described above, it is possible to realize the processing functions of the design sheet creation apparatus 10. Note that the information processing apparatus 1 of the first embodiment may also be implemented with the same hardware as that of the design sheet creation apparatus 10 of FIG. 12.

The design sheet creation apparatus 10 provides the processing functions of the second embodiment by executing a program stored in a computer-readable storage medium, for example. The program describing operations to be executed by the design sheet creation apparatus 10 may be stored in various storage media. For example, the program to be executed by the design sheet creation apparatus 10 may be stored in the HDD 103.

The processor 101 loads at least part of the program from the HDD 103 into the memory 102 so as to execute the program. The program to be executed by a server 100 may also be stored in a portable storage medium, such as the optical disc 204, the memory device 205, the memory card 207, and the like.

The program stored in the portable storage medium may be executed after being installed into the HDD 103 under the control of, for example, the processor 101. Further, the processor 101 may execute the program by reading the program directly from the portable storage medium.

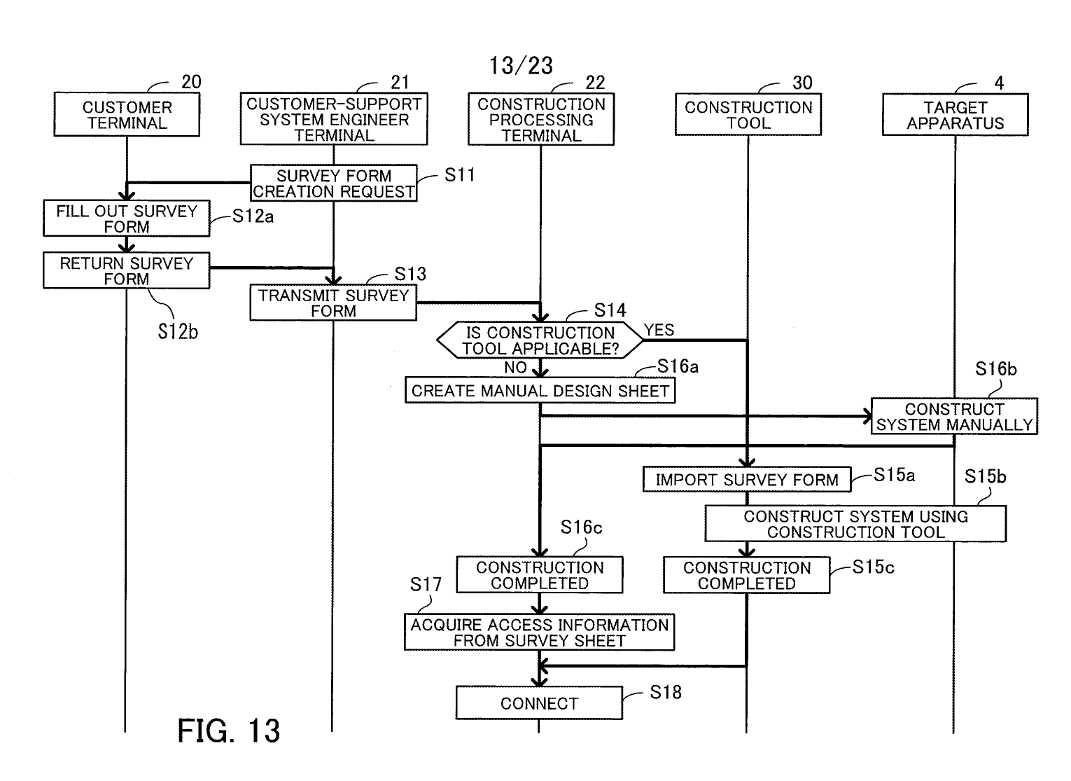

In the following, the operation will be described with reference to sequence diagrams of FIGS. 13 to 18. FIGS. 13 to 18 are operation sequence diagrams each related to creation of a machine-made design sheet. FIG. 13 illustrates an operation sequence in which the construction processing terminal 22 receives a survey form from the customer and connects to the design sheet creation apparatus 10.

(Step S11) The customer-support system engineer terminal 21 transmits a survey form creation request to a customer terminal 20.

(Step S12a) The customer terminal 20 writes access information and so on to the survey form.

(Step S12b) The customer terminal 20 returns the survey form to the customer-support system engineer terminal 21.

(Step S13) The customer-support system engineer terminal 21 transmits the survey form to the construction processing terminal 22 in the factory.

(Step S14) The construction processing terminal 22 determines whether the construction tool 30 is applicable. If the construction tool 30 is applicable, the process proceeds to step S15a. If the construction tool 30 is not applicable, the process proceeds to step S16a.

(Step S15a) The construction tool 30 imports the survey form.

(Step S15b) The construction tool 30 automatically constructs the business system 40 that includes a target apparatus 4.

(Step S15c) The construction tool 30 completes the automatic construction of the business system 40.

(Step S16a) The construction processing terminal 22 creates the manual design sheet.

(Step S16b) The construction processing terminal 22 performs manual construction of the business system 40, based on the manual design sheet, the construction procedure, and so on.

(Step S16c) The construction processing terminal 22 completes the manual construction of the business system 40.

(Step S17) The construction processing terminal 22 acquires access information (IP system, ID, password, and community name of SNMP) from the survey form.

(Step S18) The construction processing terminal 22 connects to the design sheet creation apparatus 10.

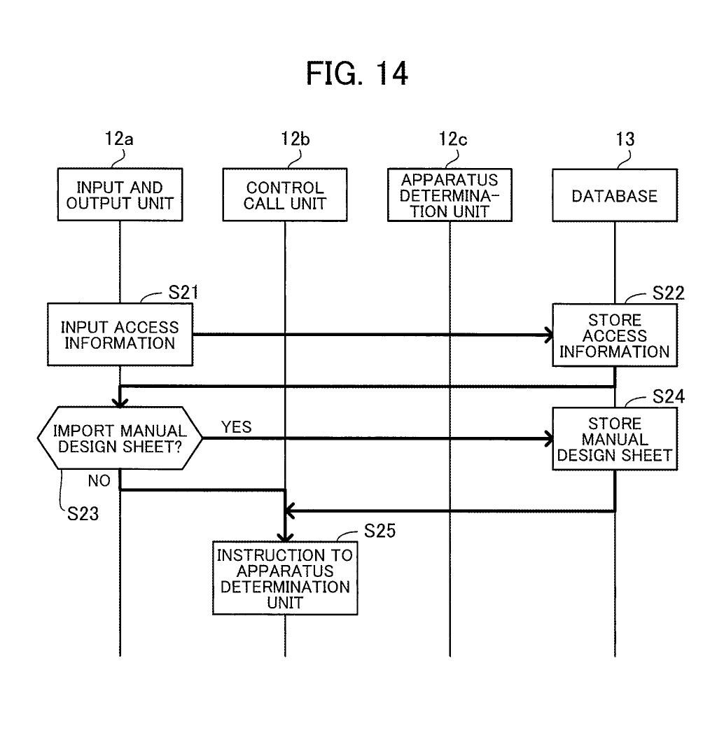

FIG. 14 illustrates an operation sequence in which, after the construction processing terminal 22 connects to the design sheet creation apparatus 10, the input and output unit 12a of the design sheet creation apparatus 10 inputs access information, and the apparatus determination unit 12c operates.

(Step S21) The input and output unit 12a inputs access information (IP system, ID, password, and community name of SNMP).

(Step S22) The input and output unit 12a stores the access information in the database 13.

(Step S23) The input and output unit 12a determines whether to import a manual design sheet. If a determination is made to import a manual design sheet, the process proceeds to step S24. If a determination is made not to import a manual design sheet, the process proceeds to step S25.

(Step S24) The input and output unit 12a stores the manual design sheet in the database 13.

(Step S25) The control call unit 12b instructs the apparatus determination unit 12c to perform an apparatus determination process.

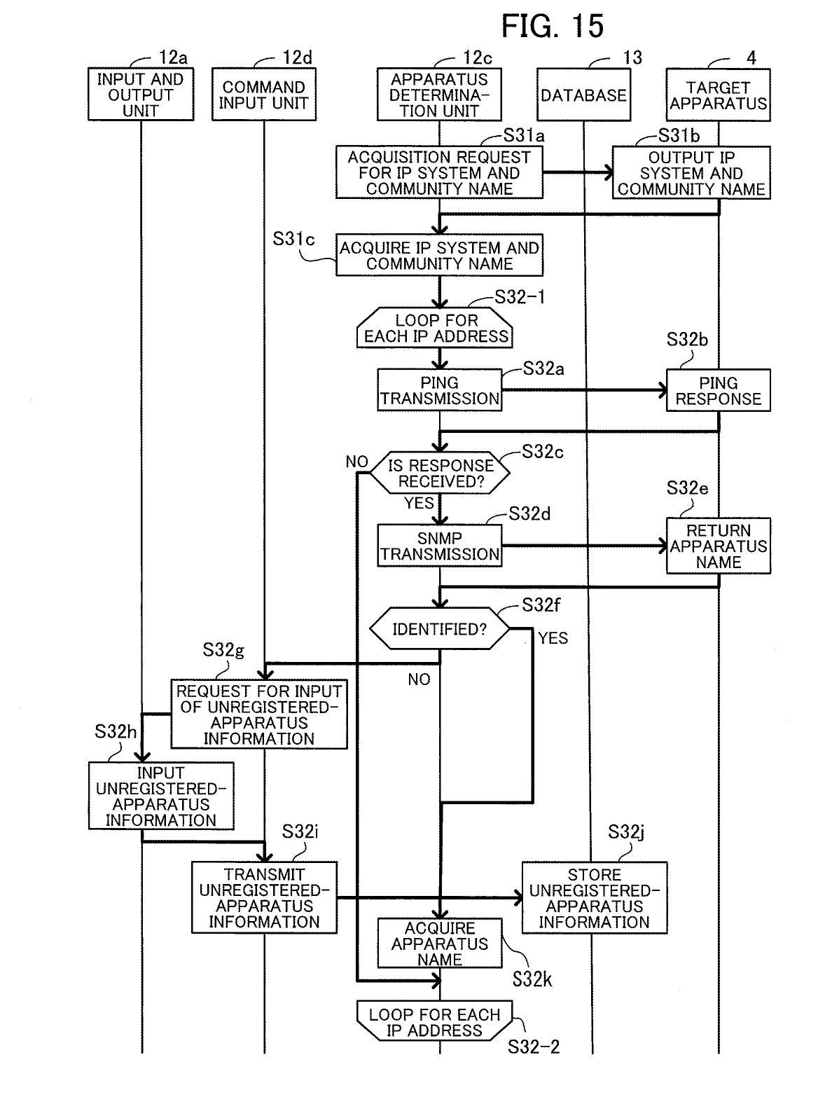

FIG. 15 illustrates an operation sequence of a process of determining an apparatus included in the business system 40 and a process of newly registering an unregistered apparatus.

(Step S31a) The apparatus determination unit 12c transmits an acquisition request for the IP system and community name to the target apparatus 4.

(Step S31b) The target apparatus 4 outputs the IP system and the community name.

(Step S31c) The apparatus determination unit 12cacquires the IP system and the community name.

(Step S32-1) The apparatus determination unit 12c starts a loop that executes an apparatus determination once for each IP address of the IP system.

(Step S32a) The apparatus determination unit 12c pings the IP address of the target apparatus 4, based on the acquired IP address.

(Step S32b) The target apparatus 4 having the pinged IP address transmits a ping response to the apparatus determination unit 12c.

(Step S32c) The apparatus determination unit 12c determines whether a ping response to the acquired IP address is received. If a ping response is received, the process advances to step S32d. If no ping response is received, the count is incremented by one, and the process returns to step S32a.

(Step S32d) The apparatus determination unit 12c transmits, for example, an SNMP-GET command as a command for determining the target apparatus 4 that has transmitted the ping response.

The SNMP-GET command is a command for obtaining the object value corresponding to a specified object ID (OID).

The SNMP-GET command is in the following format: snmpget-v <version> -c <community name> <OID>.

(Step S32e) The target apparatus 4 having received the SNMP-GET command returns inventory information including the apparatus name, the serial number, and so on to the apparatus determination unit 12c. For example, assume that an SNMP-GET command “snmpget -v 2c -c public 192.168.80.21 1.3.6.1.4.1.231.2.10.2.2.10.2.3.1.5.1” is executed, and the execution result “SNMPv2-SMI::enterprises.231.2.10.2.2.10.2.3.1.5.1=STRING: “PRIMERGY RX200 S8”” is obtained.

In this case, the name following “STRING:” in the execution result is the name of the target apparatus included in the business system, and is used for apparatus determination.

(Step S32f) The apparatus determination unit 12c refers to the apparatus information table 13-3 of the database 13, and determines whether the received apparatus name is identified. If the apparatus name is identified, the process proceeds to step S32k. If the apparatus name is not identified, the process proceeds to step S32g.

(Step S32g) The command input unit 12d transmits an input request for unregistered-apparatus information to the input and output unit 12a. The unregistered-apparatus information includes, for example, the name of an unregistered apparatus, and a configuration information acquisition command for the unregistered apparatus.

(Step S32h) The input and output unit 12a inputs unregistered-apparatus information.

(Step S32i) The command input unit 12d transmits the unregistered-apparatus information to the database 13.

(Step S32j) The database 13 stores the unregistered-apparatus information.

(Step S32k) The apparatus determination unit 12c acquires the apparatus name corresponding to the acquired IP address.

(Step S32-2) The apparatus determination unit 12c ends the loop that executes an apparatus determination once for each IP address.

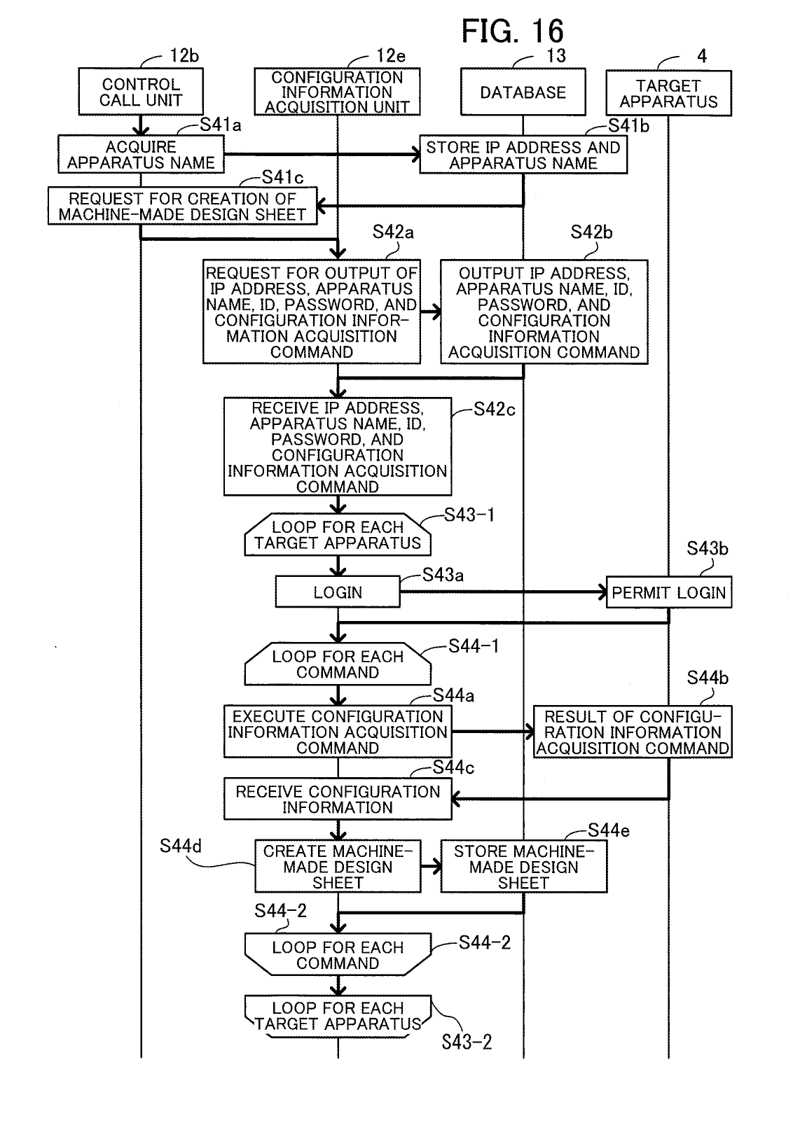

FIG. 16 illustrates an operation sequence in which a configuration information acquisition command is executed on a target apparatus and a machine-made design sheet is created.

(Step S41a) The control call unit 12b receives the apparatus name from the apparatus determination unit 12c, and transmits the apparatus name together with the corresponding IP address to the database 13.

(Step S41b) The database 13 stores the IP address and the apparatus name in association with each other.

(Step S41c) The control call unit 12b transmits a request for creation of a machine-made design sheet to the configuration information acquisition unit 12e.

(Step S42a) The configuration information acquisition unit 12e transmits an output request for the IP address, apparatus name, ID, password, and configuration information acquisition command to the database 13.

(Step S42b) The database 13 outputs the IP address, apparatus name, ID, password, and configuration information acquisition command.

(Step S42c) The configuration information acquisition unit 12e receives the IP address, apparatus name, ID, password, and configuration information acquisition command.

(Step S43-1) The configuration information acquisition unit 12e starts a loop that executes once for each determined target apparatus.

(Step S43a) The configuration information acquisition unit 12e logs in to the target apparatus 4.

(Step S43b) If the login is permitted, the target apparatus 4 notifies the configuration information acquisition unit 12e that the login is permitted.

(Step S44-1) Upon recognizing the login permission, the configuration information acquisition unit 12e starts a loop that executes once for each configuration information acquisition command.

(Step S44a) The configuration information acquisition unit 12e executes a configuration information acquisition command on the target apparatus 4.

(Step S44b) The target apparatus 4 transmits the execution result of the configuration information acquisition command to the configuration information acquisition unit 12e.

(Step S44c) The configuration information acquisition unit 12e receives the execution result of the configuration information acquisition command (configuration information of the target apparatus 4).

(Step S44d) The configuration information acquisition unit 12e creates a machine-made design sheet based on the acquired configuration information, and transmits the machine-made design sheet to the database 13.

(Step S44e) The database 13 stores the machine-made design sheet.

(Step S44-2) The configuration information acquisition unit 12e ends the loop that executes once for each configuration information acquisition command.

(Step S43-2) The configuration information acquisition unit 12e ends the loop that executes once for each determined target apparatus.

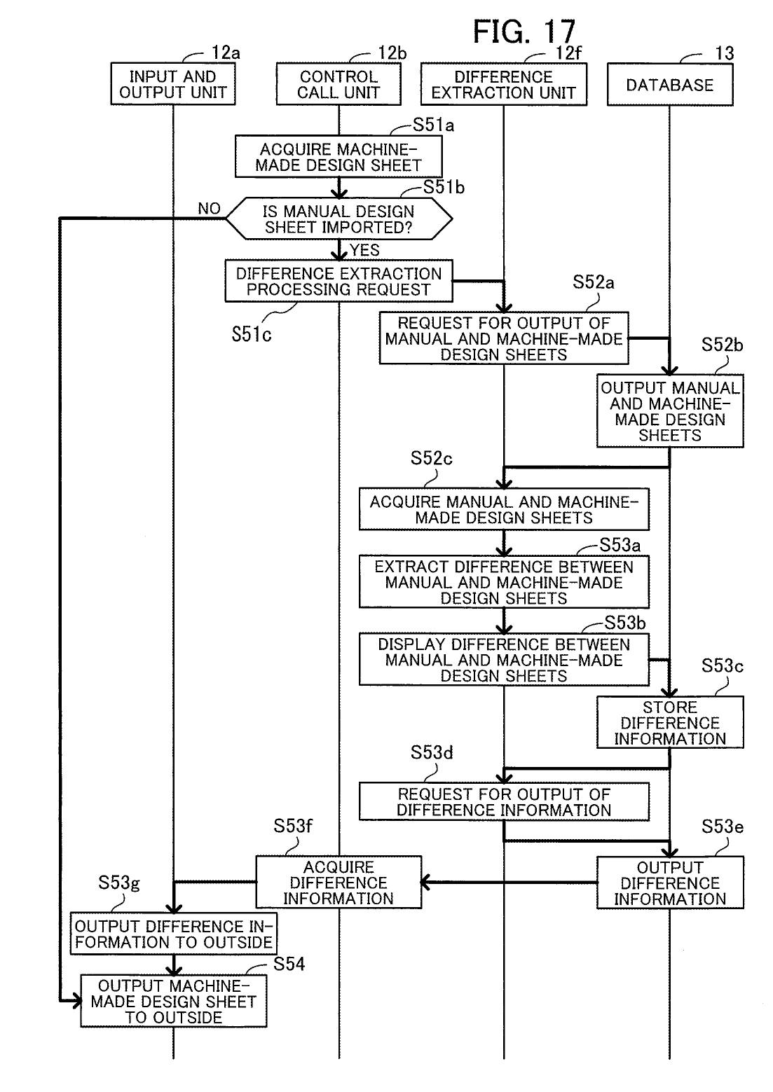

FIG. 17 illustrates an operation sequence of extraction of difference information between a manual design sheet and a machine-made design sheet.

(Step S51a) The control call unit 12b acquires a machine-made design sheet from the database 13.

(Step S51b) The control call unit 12b determines whether a manual design sheet is imported in the database 13. If a manual design sheet is imported, the process proceeds to step S51c. If a manual design sheet is not imported, the process proceeds to step S54.

(Step S51c) The control call unit 12b transmits a difference extraction processing request to the difference extraction unit 12f.

(Step S52a) The difference extraction unit 12f transmits an output request for a manual design sheet and a machine-made design sheet to the database 13.

(Step S52b) The database 13 outputs a manual design sheet and a machine-made design sheet.

(Step S52b) The difference extraction unit 12f acquires the manual design sheet and the machine-made design sheet.

(Step S53a) The difference extraction unit 12f extracts difference information between the manual design sheet and the machine-made design sheet.

(Step S53b) The difference extraction unit 12f displays the manual design sheet and the machine-made design sheet, and transmits the difference information to the database 13.

(Step S53c) The database 13 stores the difference information.

(Step S53d) The difference extraction unit 12f transmits an output request for difference information to the database 13.

(Step S53e) The database 13 outputs the difference information.

(Step S53f) The control call unit 12b acquires the difference information, and transmits the difference information to the input and output unit 12a.

(Step S53g) The input and output unit 12a outputs the difference information to the outside (to the construction processing terminal 22).

(Step S54) The input and output unit 12a outputs the machine-made design sheet to the outside.

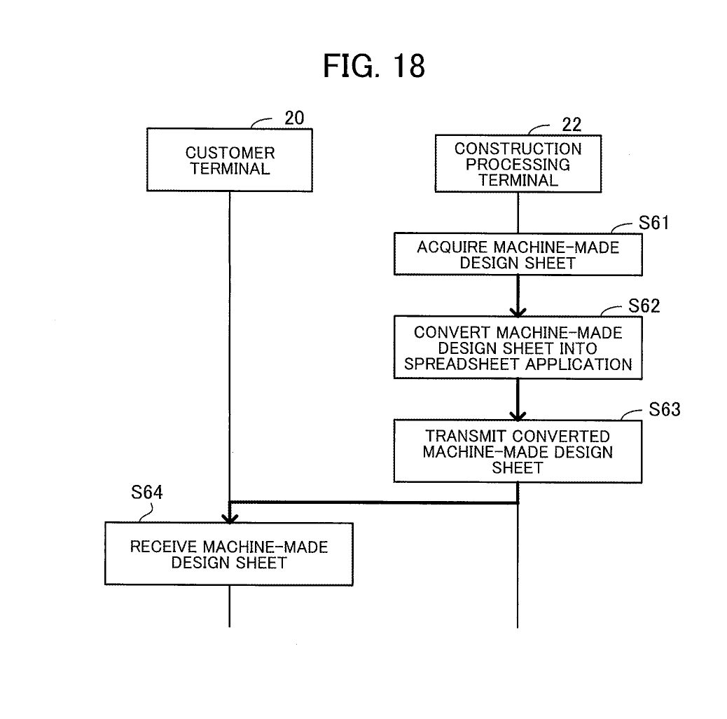

FIG. 18 illustrates an operation sequence in which a machine-made design sheet is transmitted from the construction processing terminal 22 to the customer terminal 20.

(Step S61) The construction processing terminal 22 acquires a machine-made design sheet from the design sheet creation apparatus 10.

(Step S62) The construction processing terminal 22 converts the machine-made design sheet into a spreadsheet application (for example, Microsoft Excel (registered trademark)).

(Step S63) The construction processing terminal 22 transmits the converted machine-made design sheet to the customer terminal 20 (or to the customer-support system engineer terminal 21).

(Step S64) The customer terminal 20 receives the machine-made design sheet.

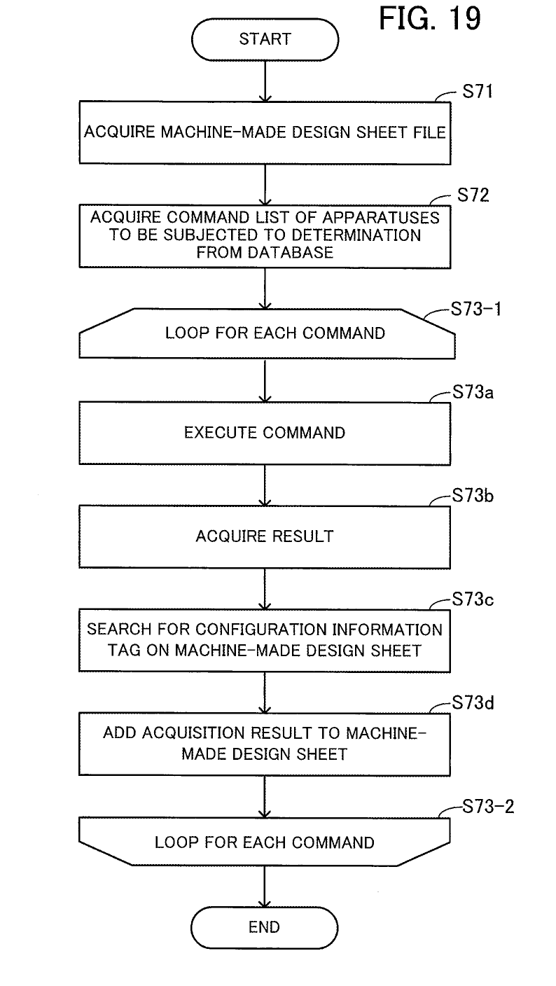

In the following, an operation of writing the execution result of a configuration information acquisition command to a machine-made design sheet will be described. FIG. 19 is a flowchart illustrating a procedure for writing the execution result of a configuration information acquisition command to a machine-made design sheet.

(Step S71) The configuration information acquisition unit 12e acquires a machine-made design sheet file.

(Step S72) The configuration information acquisition unit 12e acquires a command list of configuration information acquisition commands for apparatuses to be subjected to determination, from the database 13.

(Step S73-1) The configuration information acquisition unit 12e starts a loop that executes once for each configuration information acquisition command.

(Step S73a) The configuration information acquisition unit 12e executes a configuration information acquisition command (for example, show hostname).

(Step S73b) The configuration information acquisition unit 12e acquires configuration information (for example, hogehoge) as the result of the configuration information acquisition command.

(Step S73c) The configuration information acquisition unit 12e searches for a configuration information tag (for example, <hostname></hostname>) on the machine-made design sheet.

(Step S73d) The configuration information acquisition unit 12e adds the configuration information as the acquisition result to the machine-made design sheet (for example, <hostname>hogehoge</hostname>).

(Step S73-2) The configuration information acquisition unit 12e ends the loop that executes once for each configuration information acquisition command.

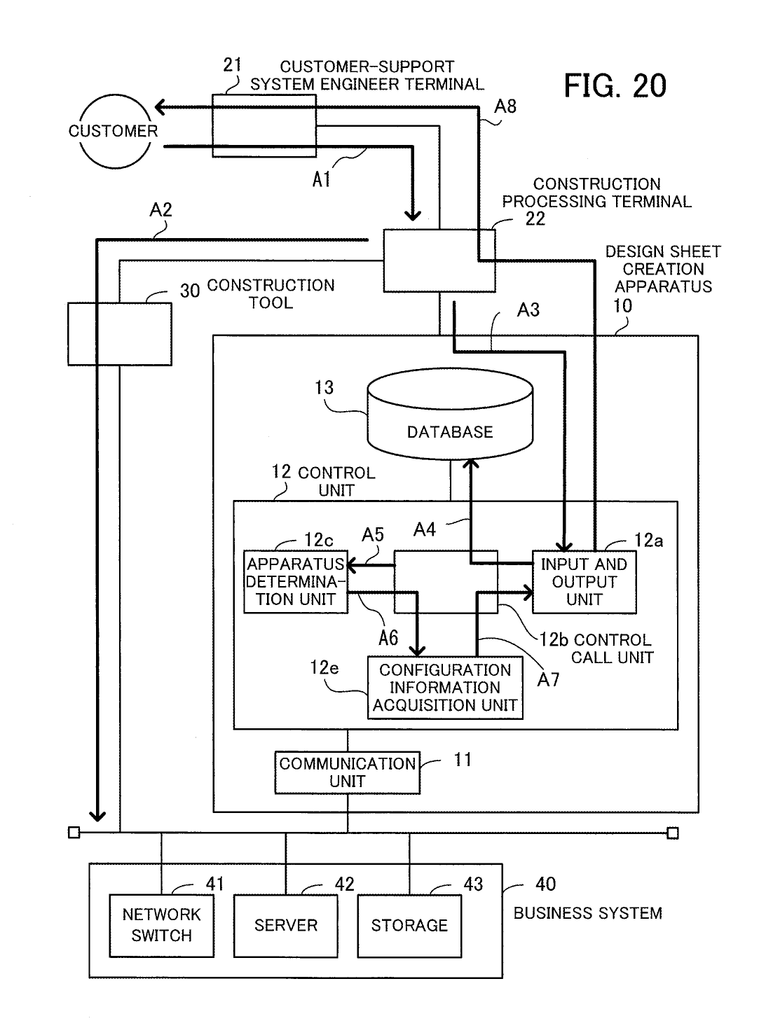

In the following, operational flows for creating a machine-made design sheet will be described with reference to FIGS. 20 to 22. FIG. 20 illustrates an operational flow for creating a machine-made design sheet. More specifically, FIG. 20 illustrates an operational flow in the case where apparatuses included in the business system are registered in advance in the design sheet creation apparatus 10.

(Step A1) The customer-support system engineer terminal 21 transmits a survey form received from the customer to the construction processing terminal 22.

(Step A2) The construction processing terminal 22 inputs information contained in the survey form to the construction tool 30, and automatically constructs the business system 40 using the construction tool 30.

(Step A3) The construction processing terminal 22 inputs access information contained in the survey form to the input and output unit 12a of the design sheet creation apparatus 10.

(Step A4) The input and output unit 12a stores the access information in the database 13 via the control call unit 12b.

(Step A5) The control call unit 12b calls the apparatus determination unit 12c. The apparatus determination unit 12c performs apparatus determination control.

(Step A6) The control call unit 12b calls the configuration information acquisition unit 12e. The configuration information acquisition unit 12e acquires configuration information of the determined apparatuses to create a machine-made design sheet.

(Step A7) The configuration information acquisition unit 12e transmits the machine-made design sheet to the input and output unit 12a. The input and output unit 12a outputs the machine-made design sheet.

(Step A8) The construction processing terminal 22 converts the machine-made design sheet into a spreadsheet application, and delivers the converted machine-made design sheet to the customer via the customer-support system engineer terminal 21.

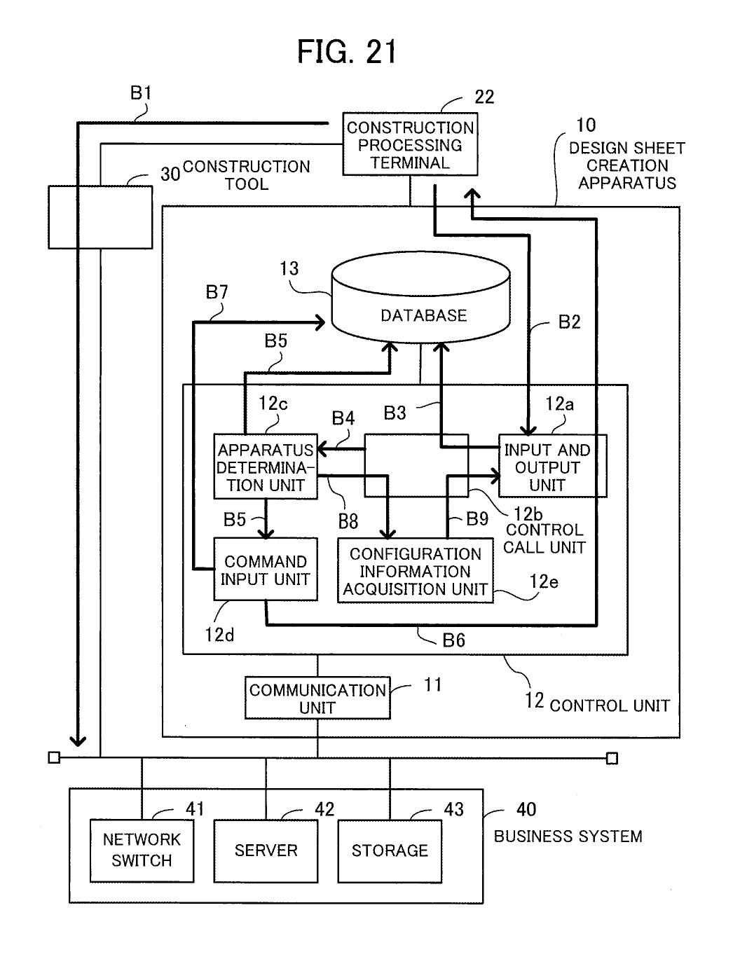

FIG. 21 illustrates an operational flow in the case where there is an unregistered apparatus when creating a machine-made design sheet. More specifically, FIG. 21 illustrates an operational flow in the case where there is an apparatus not registered in the design sheet creation apparatus 10 among apparatuses included in the business system.

(Step B1) The construction processing terminal 22 automatically constructs the business system 40 using the construction tool 30.

(Step B2) The construction processing terminal 22 inputs access information contained in the survey form to the input and output unit 12a of the design sheet creation apparatus 10.

(Step B3) The input and output unit 12a stores the access information in the database 13 via the control call unit 12b.

(Step B4) The control call unit 12b calls the apparatus determination unit 12c. The apparatus determination unit 12c performs apparatus determination control, and recognizes that there is an apparatus not registered in the database 13 from the determination result.

(Step B5) The apparatus determination unit 12c notifies the command input unit 12d that there is an unregistered apparatus.

(Step B6) The command input unit 12d notifies the construction processing terminal 22 that a configuration information acquisition command for the unregistered apparatus needs to be input, via the input and output unit 12a.

(Step B7) The command input unit 12d stores the input configuration information acquisition command in the database 13.

(Step B8) The control call unit 12b calls the configuration information acquisition unit 12e. The configuration information acquisition unit 12e acquires configuration information of the determined apparatuses to create a machine-made design sheet.

(Step B9) The configuration information acquisition unit 12e transmits the machine-made design sheet to the input and output unit 12a. Note that the machine-made design sheet is output to the construction processing terminal 22 by the input and output unit 12a.

As described above, in the case where an apparatus included in the business system is not registered, the command input unit 12d requests an external apparatus to input a command for the unregistered apparatus. Accordingly, even in the case where there is an unregistered apparatus, since it is immediately prompted to perform additional registration of information on the unregistered apparatus, it is possible to smoothly create a machine-made design sheet.

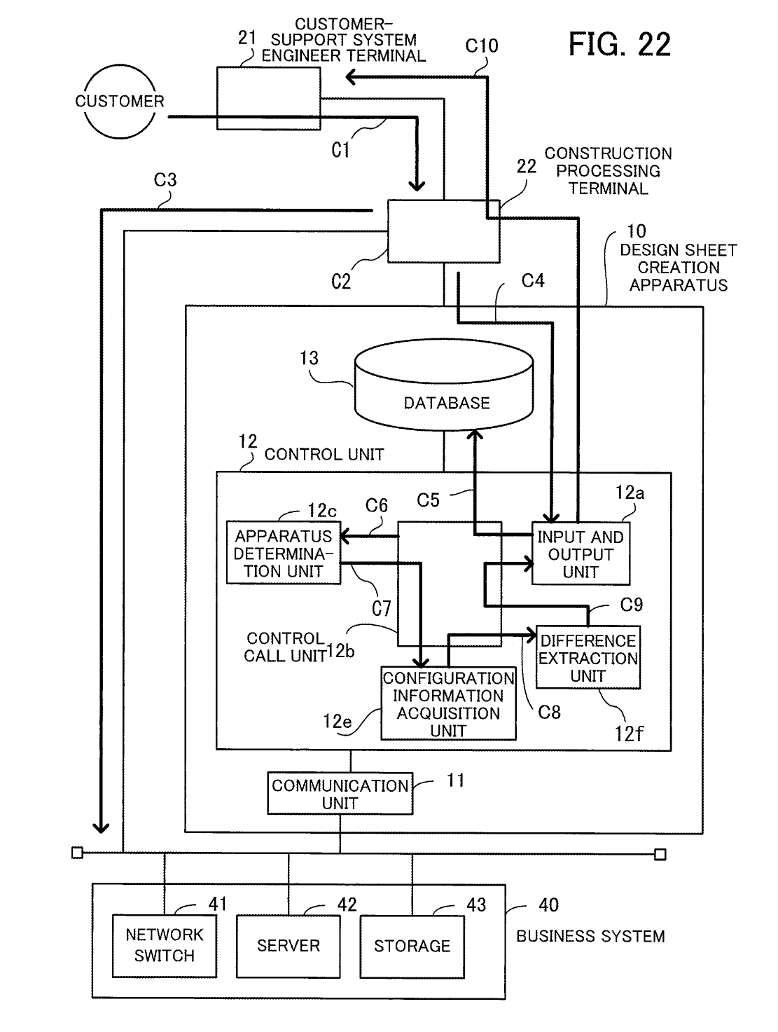

FIG. 22 illustrates an operational flow for outputting difference information when creating a machine-made design sheet. More specifically, FIG. 22 illustrates an operational flow for creating a machine-made design sheet and extracting the difference between the machine-made design sheet and a manual design sheet.

(Step C1) The customer-support system engineer terminal 21 transmits a survey form received from the customer to the construction processing terminal 22.

(Step C2) The construction processing terminal 22 creates a manual design sheet in advance.

(Step C3) The construction processing terminal 22 performs manual construction of the business system 40, based on the survey form and the manual design sheet.

(Step C4) The construction processing terminal 22 inputs access information contained in the survey form to the input and output unit 12a of the design sheet creation apparatus 10, and imports the manual design sheet.

(Step C5) The input and output unit 12a stores the access information and the manual design sheet in the database 13 via the control call unit 12b.

(Step C6) The control call unit 12b calls the apparatus determination unit 12c. The apparatus determination unit 12c performs apparatus determination control.

(Step C7) The control call unit 12b calls the configuration information acquisition unit 12e. The configuration information acquisition unit 12e acquires configuration information of the determined apparatuses to create a machine-made design sheet.

(Step C8) The difference extraction unit 12f extracts difference information between the machine-made design sheet and the manual design sheet.

(Step C9) The difference extraction unit 12f transmits the machine-made design sheet and the difference information to the input and output unit 12a.

(Step C10) The input and output unit 12a outputs the machine-made design sheet and the difference information. The construction processing terminal 22 converts the machine-made design sheet, and transmits the converted machine-made design sheet and the difference information to the customer-support system engineer terminal 21.

As described above, the difference extraction unit 12f extracts the difference between the machine-made design sheet and the manual design sheet to output the difference information. This allows the operator to easily determine the difference between the machine-made design sheet and the manual design sheet. Accordingly, it is possible to reduce the amount of man-hours, and easily handle creation errors in creating the manual design sheet.

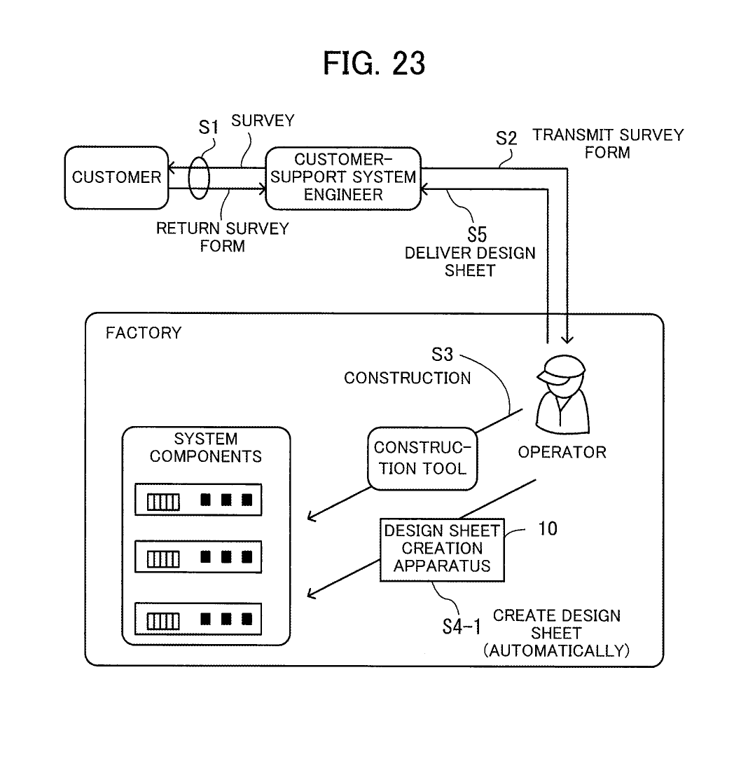

FIG. 23 illustrates the flow of creating a machine-made design sheet using the design sheet creation apparatus 10 after construction of a business system, and delivering the design sheet. Note that steps S1 to S3 and step S5 are the same as those of FIG. 2.

In step S4-1, the operator inputs access information contained in the received survey form to the design sheet creation apparatus 10. The design sheet creation apparatus 10 automatically performs the process for determining an apparatus included in a business system, acquiring configuration information specified for the apparatus, and creating a design sheet listing the configuration information.

By creating a design sheet using the design sheet creation apparatus 10 described above, it is possible to improve the work efficiency. It is also possible to improve the quality of the design sheet, reduce the amount of man-hours needed to create the design sheet, reduce the period of creation, and shorten the delivery time.

According to an aspect, it is possible to improve the work efficiency.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory configured to store a command for acquiring configuration information from an apparatus, in association with a name of the apparatus; and
a processor configured to perform a procedure including:
acquiring a name of a target apparatus that is subjected to acquisition of configuration information, by accessing the target apparatus present on a network, based on access information for accessing the target apparatus,
acquiring the configuration information from the target apparatus, by causing the target apparatus to execute the command associated with the name of the target apparatus, and
creating a configuration information list listing the configuration information.

2. The information processing apparatus according to claim 1, wherein the procedure further includes, when the command corresponding to the name of the target apparatus is not stored in the memory, outputting an input request for the command for acquiring the configuration information from the target apparatus, and storing the command that is input in response to the input request, in association with the name of the target apparatus.

3. The information processing apparatus according to claim 1, wherein the procedure further includes, when another configuration information list that is input from outside is stored in the memory, extracting difference information between the created configuration information list and the another configuration information list.

4. The information processing apparatus according to claim 1, wherein:
the access information indicates a range of addresses used by the target apparatus; and
the acquiring the name includes
transmitting a first command for determining whether the target apparatus is present to each of the addresses within the range,
when a response to the first command transmitted to a specific address is received, transmitting a second command for querying the name of the target apparatus to the specific address, and
acquiring the name of the target apparatus from information returned in response to the second command.

5. A method for creating a configuration information list, the method comprising:
acquiring, by a processor, a name of a target apparatus that is subjected to acquisition of configuration information, by accessing the target apparatus present on a network, based on access information for accessing the target apparatus;
acquiring, by the processor, the configuration information from the target apparatus, by referring to a memory configured to store a command for acquiring the configuration information from the target apparatus, in association with the name of the target apparatus, and by causing the target apparatus to execute the command associated with the name of the target apparatus; and
creating, by the processor, a configuration information list listing the configuration information.

6. A non-transitory computer-readable storage medium storing a computer program that causes a computer to perform a procedure comprising:
acquiring a name of a target apparatus that is subjected to acquisition of configuration information, by accessing the target apparatus present on a network, based on access information for accessing the target apparatus;
acquiring the configuration information from the target apparatus, by referring to a memory configured to store a command for acquiring the configuration information from the target apparatus, in association with the name of the target apparatus, and by causing the target apparatus to execute the command associated with the name of the target apparatus; and
creating a configuration information list listing the configuration information.
